(19) United States
(12) Patent Application Publication
(10) Pub. No.: US 2026/0333039 A1
(43) Pub. Date: Oct. 22, 2026

(54) AUTONOMOUS ARTIFICIAL INTELLIGENCE (AI) AGENT SESSION GOVERNANCE THROUGH NEURAL NETWORK-DRIVEN CONTINUOUS BIOMETRIC IDENTITY AND VOLITION AUTHENTICATION

(71) Applicants: Dorian Cartwright, San Jose, CA (US); James David Grundy, San Diego, CA (US)

(72) Inventors: Dorian Cartwright, San Jose, CA (US); James David Grundy, San Diego, CA (US)

(21) Appl. No.: 19/564,205

(22) Filed: Mar. 12, 2026

(51) Int. Cl. H04W 12/065; H04W 12/082; H04W 12/63

(52) U.S. Cl. CPC H04W 12/065; H04W 12/082; H04W 12/63

(57) ABSTRACT

Key-Value (KV) cache content within high-bandwidth memory (HBM) is wiped when governance of autonomous artificial intelligence (AI) agent sessions experience authentication anomalies. A continuous stream of electrocardiogram (ECG) data is received from a sensor proximate to a user and input into a neural network. The neural network, which may be a Convolutional Neural Network (CNN) for edge-inference or a Graph Convolutional Network (GCN) for lead-dependency mapping, analyzes the live cardiac signal to generate an authentication score comprising a signature match and a liveness score. An active session state for the autonomous AI agent is maintained only while the authentication score exceeds a threshold. Responsive to the score falling below the threshold, the system executes an asynchronous session lockout using the KV cache wipe.

### FIELD OF THE INVENTION

The present disclosure generally relates to computer systems and artificial intelligence (AI) and, more specifically, to governance of autonomous AI agent sessions with continuous neural network-driven authentication.

### BACKGROUND

Highly sensitive data, such as patient health records and financial transactions, needs concomitant highly-reliably authentication processes for security purposes. In the oncoming age of autonomous agents, such as the OpenClaw architecture, authorized sessions provide deep-level permissions for a chain of sensitive transactions.

Problematically, the current security methods do not match the modern level of vulnerabilities. Traditional biometrics (FaceID, fingerprints) are “discrete” events that authenticate a user at a single point in time. These techniques are vulnerable to security unlocking even when the authenticated user is no longer present, or in control, also known as a Session Hijack. Static biometrics lack intrinsic liveness detection, making them susceptible to spoofing via high-resolution imagery or post-mortem biological artifacts.

Thus, there exists a technical need for a system that moderates autonomous AI agent sessions with continuous biometric authentication that, when violated, results in deterministic, hardware-level memory protection at the LLM.

### SUMMARY

To address these shortcomings, systems, methods, and software program products provide governance of autonomous AI agent sessions through continuous biometric monitoring that, when violated, results in deterministic, hardware-level memory protection at the LLM.

In various embodiments, the system secures highly sensitive agentic workflows by actively eliminating latent memory persistence. Specifically, responsive to a detected anomaly in user authentication or governance policies, the system executes an immediate, asynchronous session lockout comprising a deterministic, hardware-level memory wipe of the AI agent's Key-Value (KV) cache partitioned within high-bandwidth memory (HBM) at the remote LLM. This hardware wipe physically destroys the specific key tensors and value tensors derived from the user's tokenized session context, bypassing standard operating-system-level context clearing to instantly neutralize advanced prompt leakage and cache-sharing exploits.

In further embodiments, the system implements advanced, multi-tiered revocation logic for the KV cache. To comprehensively secure distributed architectures, the system may execute a synchronized, multi-layer memory wipe that purges local authentication device RAM, host operating system buffers, and the remote GPU HBM simultaneously. Alternatively, to manage transient technical anomalies such as network latency, the system may execute a soft wipe and quarantine protocol, selectively removing and encrypting highly sensitive KV tensors during marginal confidence bands.

In critical embodiments, the asynchronous session lockout and KV cache memory-wipe are dynamically triggered by a continuous neural network-driven biometric authentication system. The system features a single or dual-path biometric identity architecture configured to operate in one more distinct neural modes depending on hardware constraints. A first option is an edge-optimized mode utilizing a 1D-Convolutional Neural Network (CNN) quantized to run on low-power wearables, extracting temporal features from an electrocardiogram (ECG) signal. A second option is a high-fidelity mode utilizing a Graph Convolutional Network (GCN) that treats a 12-lead ECG as a spatial-temporal graph to capture the 3D electrical geometry of the heart. The continuous biometric signals (identity, liveness, and volition) act as a continuous cryptographic gating mechanism, maintaining the active session state only while the generated authentication scores exceed a predefined threshold.

In still other embodiments, session governance extends beyond biological gating through the deployment of a secondary autonomous AI agent. This secondary proxy continuously monitors the primary agent for operational policy violations and can autonomously trigger the KV cache memory-wipe as an inter-agent kill-switch, even if the primary biometric signals remain valid. In some cases, two or more independent agentic sessions are authenticated by a single user. In other cases, two or more user authentications are required for a single agentic session.

Advantageously, these systems are improved with resilient, hardware-backed session security that neutralizes vulnerabilities in modern AI infrastructures.

### BRIEF DESCRIPTION OF FIGURES

In the following drawings, like reference numbers are used to refer to like elements. Although the following figures depict various examples of the invention, the invention is not limited to the examples depicted in the figures.

FIG. 1 is a block diagram illustrating governance of autonomous AI agent sessions with continuous neural network-driven authentication, according to an embodiment.

FIG. 2 is a schematic diagram illustrating a system for single or dual-path, neural network-driven continuous biometric identity, liveness, and volition authentication for an agentic session, according to an embodiment.

FIG. 3 is a block diagram illustrating a KV cache at the LLM, from the system of FIG. 2, with session data during agentic session and after being wiped when disabled, according to an embodiment.

FIG. 4 is a flow chart illustrating a method for governance of autonomous AI agent sessions with continuous neural network-driven authentication, according to an embodiment.

FIG. 5 is a flow chart illustrating a step of continuous biometric and volition authentication, from the method of FIG. 4, according to an embodiment.

FIG. 6 is a flow chart illustrating a step of generating a wipe signal responsive to losing continuous authentication or the secondary autonomous AI agent, from the method of FIG. 4, according to an embodiment.

FIG. 7 is a flow chart illustrating a step of terminating the autonomous AI agent session, from the method of FIG. 4, according to an embodiment.

### DETAILED DESCRIPTION

The description below provides systems, methods, computer program products with non-transitory mediums storing computer-executable code (e.g., source code), for governance of autonomous AI agent sessions with continuous neural network-driven authentication. The following description, as understood by one of ordinary skill in the art, can be applied to many variations not explicitly disclosed herein, in the interest of conciseness. For example, although cardiac uniqueness is monitored via ECG throughout the following description, other biometric measurements (e.g., continuous iris/facial, fingerprint, voice, brainwave or vascular/vein, or gait detection) can be applied to the heart and alternate unique biometrics known now or in the future may also be implemented (e.g., unique vascular configurations or unique brain wave patterns).

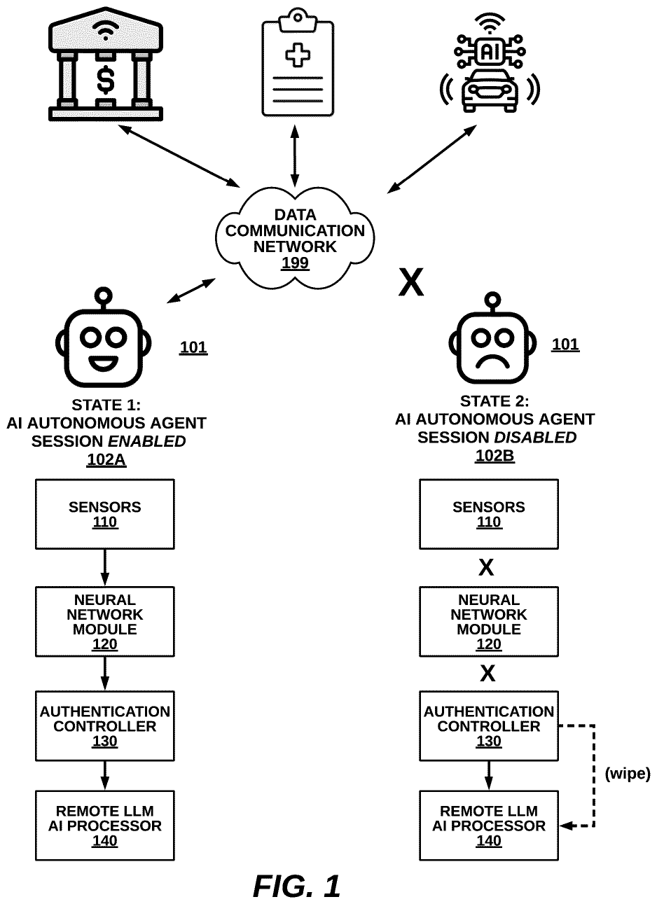

### I. System for Autonomous AI Agent Session Governance (FIGS. 1-3)

FIG. 1 is a block diagram illustrating governance of autonomous AI agent sessions with continuous neural network-driven authentication, according to an embodiment. A chatbot can be displayed or heard on a user device (e.g., a smartwatch or an autonomous vehicle) as a local interface for a human user to talk or type prompts to the autonomous AI agent which, is in turn remotely supported by a transformer-based LLM having hardware with persistent memory over a session or multiple sessions. The LLM can comprise one or more of, without limitation, Gemini, Claude, Perplexity and ChatGPT. An authentication device verifies that the human user is identified, and optionally, is living and is not under duress, while using the chatbot for highly sensitive transactions.

At state 1 101A, an AI autonomous agent session is enabled to operate on behalf of a human user or master process. An authentication process of AI-driven continuous biometric identity processes opens the gate. Liveness of user confirmation and user volition can also be part of human user authentication to ensure the human user is alive and voluntarily participating. One data path includes one or more sensors 110 receiving human user biometric and volition data, a neural network module 120 verifying the biometric and volition data against a baseline from a database or earlier in a session, an authentication controller 130 interpreting neural network module 120 responses, and, within a remotely-located LLM, an AI processor 140 executing instructions and maintaining context data or session state data for the session in hardware. Other session state data can be maintained, and wiped in tandem with KV cache hardware (e.g., in I/O buffers), in higher-layer software at the LLM (e.g., in the operating system) or locally at the authentication device (e.g., in the local processor or neural network module 120).

During the session, an autonomous AI agent 101 acts on behalf of the human user being monitored. For example, without user intervention (or minimal intervention), highly sensitive remote activities can be conducted, such as financial transactions can be conducted, health and medical transactions can be completed, and autonomous vehicle operation can be enabled. In other implementations, AI agents operate on a local device, such as a wearable device (e.g., a smartwatch) and edge inference without external resources.

At state 2 102B, the autonomous AI agent session is explicitly disabled. This can occur from various circumstances, including, without limitation, when a human user removes sensors, stands up from a chair with embedded sensors, exits an autonomous vehicle, is no longer alive, or is forced into acting. Whether it be discontinuation of continuous sensor data or an authentication score of multiple factors falling below a threshold, the hardware is cleared of session state data (e.g., data wipe, overwrite or purge) which, in turn, kills or disables the autonomous AI agent 101. It also prevents other agents or processes from collecting sensitive data which at times is in easily discernable plaintext format.

In a real-world use case, a user may enter an autonomous agent-controlled vehicle where the driving operation functions as an active agentic session. This autonomous driving session continues to operate securely only as long as the user's biological identity and/or volition are continuously confirmed, preventing unauthorized, incapacitated, or coerced operation of the vehicle. In another application, an autonomous agent tasked with completing a sensitive financial transaction requires continuous biometric confirmation from the authorized user from initiation until the transaction is fully complete, ensuring the session cannot be hijacked mid-process.

In another use case, an autonomous AI agent session facilitates wellness telemetry including a user's private medical records, via a health-oriented conversational AI interface (e.g., ChatGPT Health by Open AI). During such an active health-management session, highly sensitive Protected Health Information (PHI), including diagnostic histories, pharmaceutical records, and real-time wellness data, is tokenized and physically stored as plaintext Key and Value tensors within an HBM KV cache to maintain conversational context. To mitigate the severe risk of session hijacking and unauthorized exfiltration of this PHI, the system requires the user to maintain a continuous stream of biometric data, such as an ECG signal from a wearable smartwatch, to continuously verify the user's identity, liveness, and volition. If the biometric signal is interrupted, for instance, if the user physically departs from the terminal or is acting under duress, the authentication controller detects the loss of continuous authentication and executes an immediate, asynchronous session lockout. This lockout directly triggers the deterministic, hardware-level memory wipe of the LLM's KV cache, instantly destroying the cached medical records at the hardware level to prevent unauthorized access to the sensitive health data.

Furthermore, the system can enforce a two-sided (or more) confirmation requirement for multi-party security scenarios. For instance, a remote telemedicine visit can require continuous biometric verification from both the remote doctor and the patient. If either the doctor or the patient departs from the session, or if either party loses verified biometric liveness, the dual-confirmation requirement fails, causing the session to be immediately discontinued and the medical records to be locked. In another instance, a financial transaction can require more than one party for authentication. The additional human users can be located nearby a first human user, using a second set of sensors directly inputting to the authentication device. Alternatively, the additional human users can be located remotely, and securely transmit over the Internet, either a second continuous ECG stream from a second remote sensor or authentication from a second remote authentication device. Prior to the agentic session, thee second sensor or second authentication device can be authenticated by the first authentication device. Additionally, the system can authenticate multiple agentic sessions of a single user.

Various biometric identity techniques are possible. In some embodiments, the multimodal sensor array comprises high-density electroencephalography (EEG) sensors configured to capture the user's continuous electrical brain wave patterns, establishing a highly spoof-resistant cognitive fingerprint for identity verification. In other contact-based embodiments, near-infrared vascular sensors or continuous ultrasonic fingerprint scanners may be integrated into physical interfaces, such as an enterprise keyboard, computer mouse, or vehicle steering wheel, to continuously map the user's unique vascular and vein configurations or epidermal ridge patterns during active use. The vascular network beneath the human epidermis forms a highly complex and immutable pattern of veins and capillaries that is distinctly unique to each individual.

In mobile or wearable hardware implementations, the system may utilize on-board accelerometers and gyroscopes to perform continuous gait detection. Human gait functions as a biomechanical fingerprint resulting from an individual's specific musculoskeletal geometry, tissue density, and learned motor control patterns. By continuously monitoring kinematic features, such as stride length and joint angular momentum, along with kinetic features like ground reaction forces, the system establishes a continuous behavioral identity signature based on the specific, rhythmic mechanical patterns generated as the user moves.

For non-contact spatial environments, an optical sensor, a camera or camera array, a virtual reality headset, or augmented reality glasses may execute continuous spatial or facial recognition, as well as continuous iris tracking, to mathematically verify that the authorized user remains the active operator within the terminal's field of view. Furthermore, for voice-activated autonomous AI agents, the system may continuously sample the audio input stream to perform continuous speaker authentication by extracting and analyzing the unique acoustic features, pitch, and vocal tract geometry of the active speaker.

Conversely, the architecture can be configured to operate in reverse as a biometric safety trigger. In this embodiment, when the human user is no longer biometrically detected, indicating a potential loss of consciousness, medical emergency, or incapacitation, a designated emergency autonomous agent can be automatically initiated to take over critical operations, such as safely halting machinery, navigating a vehicle to the roadside, or executing a distress protocol.

### AI System Architecture

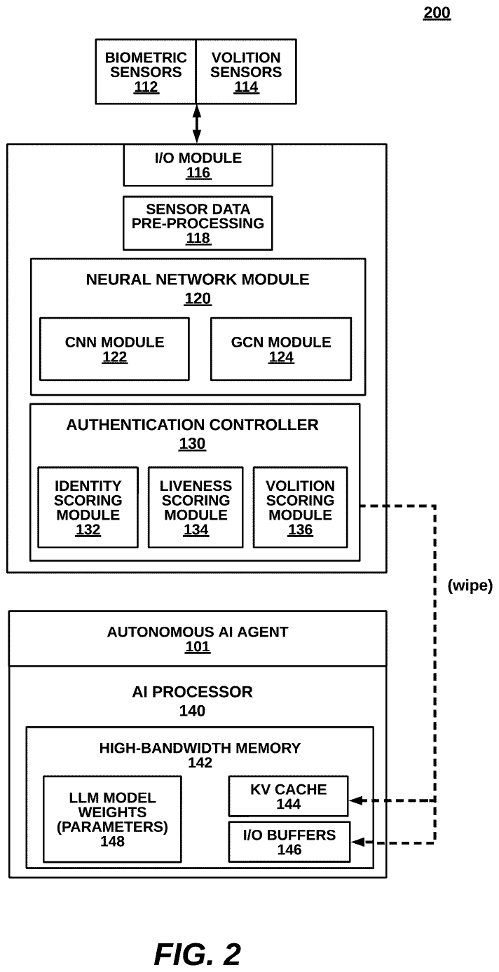

FIG. 2 is a schematic diagram illustrating a system for single or dual-path, neural network-driven continuous biometric identity, liveness, and volition authentication for an agentic session, according to an embodiment. An AI hardware infrastructure and AI software infrastructure supports autonomous AI sessions. Generally, an autonomous AI session represents a continuous period of active computation where an autonomous AI agent, operates to execute a series of tasks or a chain of sensitive transactions without requiring constant, step-by-step human prompting (e.g., the OpenClaw architecture of autonomous AI agents that check and proactively utilize e-mail, calendars, and the like). At the core of this session is the inference engine, which continuously processes incoming data and generates computational outputs. To maintain conversational context and handle long-context tasks over the duration of the workflow, these agentic frameworks rely heavily on a key-value (KV) cache. This cache physically stores processed prompt data, token histories, and intermediate attention computations within high-bandwidth memory (HBM) or offloaded persistent storage. Supporting these core functions are session management protocols that govern the communication link and access tokens between the user interface and the agent. Furthermore, dynamic memory management systems, such as a Least Recently Used (LRU) eviction policy—run in the background to handle latent memory persistence, actively overwriting older cached data as new context is generated throughout the session's lifecycle.

### Agent Context Architecture (KV Cache 142)

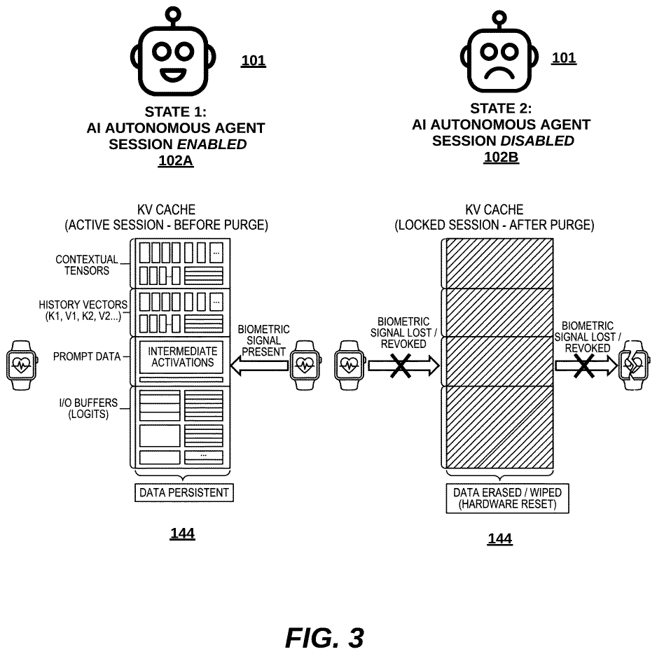

FIG. 3 is a block diagram illustrating the KV cache 144 of FIG. 2, with session data during agentic session and after being wiped when disabled, according to an embodiment. A smartwatch worn by a human user as an authentication device can send a wipe signal to the KV cache resident in HBM on an AI processor of an LLM.

The KV cache 144 architecture, in transformer-based models and LLMs driving active AI sessions, serves as a critical optimization mechanism for autoregressive generation. As the inference engine processes a sequence of inputs, the attention mechanism computes complex Key and Value tensors for each token. Rather than recomputing these computationally expensive tensors for past context at every single generation step, the architecture stores them in the KV cache. To accelerate inference and handle long-context tasks, LLMs and agentic frameworks utilize this KV cache to store processed prompt data and token histories within HBM or offloaded persistent storage. However, this architectural reliance on persistent state retention creates a severe security flaw. Latent memory persistence in autonomous AI agents refers to the critical security vulnerability where highly sensitive conversational context and intermediate attention computations remain physically stored in hardware long after a user's session has nominally ended. Because conventional protocols do not actively destroy the underlying cached data, the user's proprietary information persists in a latent plaintext state within the inference engine's memory until it is passively overwritten. During this temporal window of latent persistence, the active KV cache is highly susceptible to extraction via side-channel attacks, cross-tenant cache sharing exploits, or advanced session hijacking.

A tokenization and key-value vector pipeline further details the physical memory structures targeted by the memory-wipe protocol. In more detail, the computational pipeline that transforms human-readable plaintext into the high-dimensional vector representations stored within the KV cache. When plaintext session data, such as a financial routing number or a health diagnosis code, is input into the LLM, it is first processed by a tokenizer. The tokenizer segments the continuous plaintext strings into discrete sub-word units or characters, assigning each unit a unique integer identification number derived from the model's foundational vocabulary. These integer identifiers are then mapped against a learned embedding matrix to generate dense, continuous embedding vectors (often comprising thousands of dimensions, such as 4096 or 8192) that capture the baseline semantic meaning of the tokens. Positional encodings are subsequently added to these embeddings to mathematically preserve the sequential order of the inputs.

As these embedded vectors pass into the successive attention layers of the transformer architecture, they undergo a critical mathematical transformation via matrix multiplication. Specifically, each embedded token vector is multiplied by three distinct, learned weight matrices—denoted as $W_Q$, $W_K$, and $W_V$—to project the data into three separate computational tensors: a Query ($Q$) vector, a Key ($K$) vector, and a Value ($V$) vector. The Query vector represents what the current token is “looking for” and is utilized immediately to compute attention scores. However, the resulting Key and Value tensors—which encapsulate the token's specific syntactic properties and its semantic relationship to the broader conversational context—are the actual mathematical structures that are actively appended to the KV cache partitioned within the HBM. Therefore, when the biometric session lockout executes the hardware-level wipe, it is specifically overwriting these proprietary $K$ and $V$ projection matrices, physically destroying the direct mathematical derivatives of the user's plaintext inputs.

Specific semantic contents in the KV cache are physically represented by the KV tensors and intermediate activations within the HBM during sensitive autonomous operations. While the KV cache physically stores data as high-dimensional mathematical vectors, these vectors are direct representations of plaintext session context. For example, during an autonomous financial transaction, the KV cache actively retains unencrypted banking data required for the agent to complete the workflow. This includes localized tensor representations of target account and routing numbers, session-specific API authorization tokens, transaction amounts, user PINs, and the intermediate logical steps the AI agent generated to route the funds. Similarly, when the autonomous AI agent is utilized for processing patient medical records or conducting a remote telemedicine visit, the active context window stored in the HBM contains highly sensitive Protected Health Information (PHI). The cached history vectors in these medical embodiments physically embody raw physician notes, ICD-10 diagnosis codes, pharmaceutical dosages, and patient identification data (e.g., Social Security Numbers) that the transformer architecture autoregressively depends upon to generate its next action. Because these highly confidential, highly regulated data points remain fully constructed and persistent in the HBM 142 until passively overwritten, the execution of the biometric kill-switch ensures that these specific financial instruments and HIPAA-protected health artifacts are instantly destroyed at the hardware level, neutralizing the risk of targeted side-channel data exfiltration.

To ensure that the asynchronous session lockout and subsequent memory-wipe destroy the correct KV cache contents without affecting the static model weights or the partitioned caches of other active tenants, the system executes a precise cross-path synchronization between the biometric authentication data path and the autonomous AI agent session data path. The primary convergence of these two distinct data paths occurs via a dynamic metadata injection protocol. As the continuous ECG data is processed by the feature encoders (e.g., the CNN or GCN), the authentication controller serializes the resulting latent vectors, liveness scores, and volition confidence scores into a structured metadata format, such as a JSON payload. Crucially, this structured physiological state is dynamically injected into the LLM as a continuous, hidden system prompt (e.g., <system_state>liveness: verified, volition_score: 0.98, duress_flag: false </system_state>) that is prepended directly to the user's active conversational inputs. By mathematically packaging the continuous biometric gating signal with the user's specific textual or multimodal prompt data, the LLM processes the biological authentication state as an inherent, localized component of that exact session's context.

This injected biological context operates in tandem with strict access token governance. The session management protocols explicitly govern the communication link and the specific access tokens established between the user interface and the autonomous agent. The continuous biometric identity acts as a continuous cryptographic gating mechanism for these specific access tokens. When the calculated authentication score falls below the required threshold, the authentication controller instantly revokes the unique access token assigned to that specific session, cryptographically isolating the specific agentic workflow tied to that token from the broader inference engine.

At the hardware level, this token governance directs the physical memory-wipe. Within the HBM, the KV cache is not stored in a single, commingled pool; rather, it is partitioned into dynamically allocated memory blocks that reside within the physical memory of the AI accelerator. Because the revoked access token and the hidden biological system prompts are explicitly mapped by the memory manager to these specific dynamically allocated blocks, the asynchronous session lockout command identifies the exact physical memory addresses to target. By executing a targeted physical memory overwrite exclusively on the dynamically allocated memory blocks mapped to the revoked token, the system safely destroys the correct user's proprietary $K$ and $V$ projection matrices, leaving the static LLM model weights and the active hardware partitions of other concurrent sessions completely intact and undisturbed.

The HBM 142 hardware architecture, in addition to the KV cache 144, serves as a critical repository for several other massive data structures essential for executing transformer-based LLMs and autonomous agent sessions. While the model weights, comprising billions of trained neural network parameters, represent the largest static resident of the HBM, they typically do not contain proprietary session information. However, HBM 142 also manages other highly sensitive, session-specific data, including intermediate activations of temporary mathematical states generated layer-by-layer during the forward pass, in addition to input/output buffers 146, which house actively processed token embeddings and final output logits. Because these activations and buffers contain plaintext equivalents of the user's sensitive context, the biological kill-switch protocol, in some embodiments, is configured to also perform a deterministic, hardware-level memory wipe that extends beyond the KV cache 144. Specifically, upon the loss of verified biological identity, liveness or volition, the system triggers an immediate purge of all session-dependent computational states within the HBM 142, ensuring that residual data in the I/O buffers 146 and intermediate tensor calculations are destroyed alongside the KV cache 144 to eliminate lingering vectors for data exfiltration. Because the LLM model weights (parameters) 148 represent static, foundational pre-trained logic rather than dynamic, user-specific context, they are intentionally excluded from the memory-wipe protocol and remain persistently stored and intact within the high-bandwidth memory 142.

The AI processor 130, beyond the HBM 142, is composed of several critical architectural blocks designed for massive parallel computation. The core engine consists of thousands of specialized compute units, such as NVIDIA's Tensor Cores or Google's Matrix Multiply Units (MXUs), which are purpose-built silicon for accelerating dense matrix multiplications and mixed-precision arithmetic (e.g., FP16, BF16, INT8). To feed these cores efficiently, the processor includes significant amounts of ultra-fast, on-die SRAM (Static Random-Access Memory), organized into multi-level caches (L1, L2). This on-chip memory acts as a low-latency buffer for frequently accessed model weights and intermediate activations, minimizing the need to fetch data from the slower external HBM. Linking these components is a high-speed internal interconnect fabric (network-on-chip) that manages immense data flows between cores and memory banks. Finally, advanced accelerators feature dedicated chip-to-chip interconnect interfaces, such as NVLink, allowing multiple processors to be physically linked to function as a single, unified computing resource for training oversized models. When accompanied by a CPU, in some implementations, the AI processor 130 serves as an AI accelerator, being routed to offload specific AI tasks as opposed to general tasks handled by the CPU.

The AI processor 130 can be a Graphical Processing Unit (GPU), a Tensor Processing Unit (TPU), a neural processing unit, a network processing unit, a Central Processing Unit (CPU), an Application-Specific Integrated Circuit (ASIC), a Field Programmable Gate Array (FPGA), or any other appropriate processing unit. The semiconductor chips may be manufactured by Nvidia, AMD, Intel, Cerebras, Qualcomm, Broadcom, ARM, or the like. Some embodiments are specialized for AI training and/or AI inferencing. Various implementations have one chip, while others have multiple connected chips. Data centers can specially house and utilize numerous cooperating computing devices.

Additional internal computer device components can support the AI chip, other than CPUs. The computer device can feature a system bus that communicatively couples its internal components, long-term memory that stores an operating system and other software applications. In one case, the operating system hosts a dedicated area for autonomous AI agents as applications. In another case, autonomous AI agents are given operating system-level access to applications using direct calls to an OS kernel and being able to intercept calls from applications down to the OS kernel. External communications and user interactions are handled with an I/O port, which includes a display and a network interface for connecting to the data communication network.

### Continuous Biometric and Volition Monitoring (Sensors 110)

The system executes continuous biometric authentication by receiving a continuous stream of ECG data (or other form of biometric data) from one or more sensors 110 proximate to the user, such as a smartwatch. To process this raw ECG alongside phonocardiogram data, the architecture employs a single or dual-path neural network configured for either edge-inference or lead-dependency mapping.

The uniqueness of a human ECG is the result of a complex interplay between physical anatomy and electrophysiological wiring. Every individual possesses a distinct cardiac geometry, characterized by the specific size, mass, and orientation of the heart within the chest cavity. These structural variations, combined with the unique density of the surrounding tissues, act as a biological filter that shapes the electrical signal as it travels to the skin's surface. On a cellular level, the precise distribution of conduction fibers and the specific velocity at which ions move through cardiac tissue create a personalized electrical pathway. Furthermore, because the heart is constantly influenced by the autonomic nervous system, an ECG captures a living biometric as a signature influenced by one's metabolic rate, hormonal balance, and even the subtle, unique timing intervals. While all healthy hearts share the same functional rhythm, these underlying physical and electrical nuances ensure that your heart's waveform is as individually identifiable as a fingerprint.

A multimodal biometric cardiac sensor feeds the continuous physiological state into the neural network authentication layer, the system relies on a multimodal sensor array configured to capture the heartbeat across electrical, mechanical, and acoustic domains. With respect to the ECG the raw electrical activity, electrical capture is achieved via physical contact with the user's skin, utilizing single-lead sensors embedded in a wearable smartwatch, or multi-lead contact pads integrated into a secure enterprise keyboard or chair. Operating in tandem, secondary sensors convert physical vibrations and sound into measurable electrical signals and digital data. For instance, the sensors may be embedded within a wearable device, such as a smartwatch, configured to capture raw electrical activity (ECG) via direct, single-lead skin contact, while simultaneously sensing the mechanical vibrations of the user's physical pulse. In enterprise or high-security workstation environments, the system may utilize multi-lead contact pads integrated directly into a secure enterprise keyboard or chair, capturing electrical cardiac activity through physical contact with the user's hands. Alternatively, multi-lead contact pads may be embedded within a chair to capture the raw electrical activity of the user's heart while they remain seated. Furthermore, the system supports external or remote monitoring configurations that do not require direct skin contact. These non-contact embodiments can include standalone acoustic sensors, such as a phonocardiogram, to capture the acoustic waveform of the heartbeat, as well as spatial sensors, including a breathing sensor configured to detect air intake or an iris detector configured to monitor the user's eyes over space.

The electrical output of an ECG represents the sum of all electrical activity generated by the heart's specialized conduction system and muscle fibers as they depolarize and repolarize during a cardiac cycle. This process begins at the sinoatrial (SA) node, which acts as a natural pacemaker, sending a wave of electricity across the atria to create the P wave. As the signal reaches the atrioventricular (AV) node, it experiences a brief, essential delay—visible as the PR segment—allowing the ventricles to fill with blood before contracting. The signal then rapidly descends through the Bundle of His and Purkinje fibers, triggering the massive electrical discharge of the QRS complex. This phase represents ventricular depolarization, where the large muscle mass of the lower chambers contracts to pump blood to the lungs and body. Finally, the T wave marks the repolarization phase, where the ventricles recover their electrical charge in preparation for the next beat. Measured in millivolts over time, this output is not just a simple pulse, but a sophisticated vector of energy that reflects the heart's health, rhythm, and structural integrity.

In a pre-processing phase of the pipeline, upon capture and receipt into an I/O module 116, these continuous analog waveforms must be rigorously conditioned prior to ingestion by the CNN and/or the GCN by sensor data pre-processing module 118. The analog signals, including the raw ECG and phonocardiogram, are first routed through an Analog-to-Digital Converter (ADC) to be digitized. The digitized streams are then passed through a dedicated signal conditioning layer that applies strict bandpass filtering. This crucial pre-processing step isolates the target physiological frequencies (typically between 0.5 Hz and 150 Hz for an ECG) to systematically eliminate baseline wander, motion artifacts caused by the user's movement, and high-frequency environmental noise. The resulting sanitized, digitized time-series data is then transmitted to the authentication device, providing the clean mathematical foundation required for the CNN and GCN feature encoders to accurately extract temporal features or map the 3D cardiac geometry.

The sensors 110 convert vibration, sound, and/or computer vision to electrical signals and/or digital data. For instance, vibrations of the heartbeat or pulse can be sensed by a smartwatch in contact with skin of a human user, and an ECG sensor measures electrical activity of the heart. Alternatively, a keyboard or a chair can have multi-lead contact pads. Without direct contact, a breathing sensor can hear air intake and exhalation, and an iris detector can see the human eyes over space.

Operating in parallel with the identity verification pathway, the system incorporates a multimodal volition and duress assessment module to guarantee the authenticated user is acting of their own free will. This module integrates affective AI sensor fusion, aggregating secondary physiological data streams such as respiration rates (e.g., over 20 breaths per minute) and continuous non-invasive blood pressure (cNIBP) to establish stress metrics like heart rate variability (HRV). Furthermore, optic reader inputs capture deception metrics, including iris dilation and saccadic eye movements. By continuously analyzing these stress and deception metrics against the user's established physiological baseline, the multi-gating logic generates a real-time volition confidence score. This ensures that even if the biological liveness and identity match scores are valid, the agentic workflow remains gated if the user is operating under physical coercion or duress.

Biometrics for volition determination involve the use of physiological signals to decode an individual's intent, will, or conscious decision-making process before a physical action is even initiated. At the forefront of this field is the study of pre-motor potentials, such as the Readiness Potential (or Bereitschaftspotential), which is a subtle change in electrical activity in the motor cortex that occurs hundreds of milliseconds before a person becomes consciously aware of their urge to move. By using high-density EEG, researchers can map these neural precursors to identify the volitional brain state that precedes voluntary muscle activation. Beyond the brain, other biometric markers like Electromyography (EMG) can detect subthreshold muscle micro-contractions that signal a person's intent to act, even if they ultimately inhibit the movement. These signals are increasingly being integrated into Brain-Computer Interfaces (BCI) and advanced prosthetics, allowing machines to interpret not just what a user is doing, but what they intend to do, effectively bridging the gap between biological thought and digital execution.

In some embodiments, liveness and/or volition are implemented as independent authentications systems, without biometric identity authentication. In other systems, liveness and/or volution are implemented in combination with biometric identity authentication.

### Edge Inferencing (Neural Network Module 120)

The neural network module 120 can use one or more neural-networks for deriving scores, located on-device for edge inferencing or at a data center. For battery-constrained mobile devices, an edge-optimized 1D-Convolutional Neural Network (CNN) utilizes quantized weights to run on low-power microcontrollers, extracting temporal features from R-peak intervals and QRS complex morphology. Also, the CNN alternative is specifically designed for environments where multi-lead hardware is not feasible, prioritizing inference speed over the complex graphing of the GCN. In this embodiment, the system utilizes a 1D-CNN. The primary technical advantage of this architecture is that the CNN is quantized, such as using 8-bit integer weights, which allows it to run efficiently on low-power wearable microcontrollers. Mechanistically, instead of mapping 3D geometry, it extracts temporal features directly from the R-peak intervals and QRS complex morphology of the cardiac signal.

Conversely, high-security applications utilize a GCN that models 12-lead ECG data as a spatial-temporal graph using Mutual Information (MI) indices. A local terminal streams encrypted raw data over a highly secure, low-latency data communication network for remote inferencing. Specifically, each of the 12 leads functions as a node, and MI indices are used to define the edges between these lead-nodes to represent their statistical dependencies. Because it relies on hardware capable of multi-lead contact, this architecture especially benefits high-security environments like data centers, financial terminals, and health records. This GCN approach captures the 3D electrical geometry of the heart to achieve high accuracy, establishing a highly spoof resistant 3D cardiac fingerprint. Together, these neural modes generate a liveness confidence score and a signature match, overcoming the vulnerabilities of static biometrics that lack intrinsic liveness detection. In one case, if the remote GCN verifies the identity and liveness, it sends an ongoing cryptographic approval token directly to the remote LLM server where the KV cache lives, to keep the session alive but is post-processed locally. Thus, the GCN in this case is not strictly edge inferencing, but is locally controlled relative to the LLM which is more classically remote inferencing.

Prior to ingestion by an LLM, whether used as the autonomous AI agent itself or to generate multi-modal training scenarios from the received multi-modal inputs, the raw, continuous data streams from the biometric sensors can undergo a multi-stage pre-processing and tokenization pipeline. First, the analog signals, such as the raw ECG and phonocardiogram, are digitized and passed through a signal conditioning layer that applies bandpass filtering to eliminate baseline wander, motion artifacts, and high-frequency environmental noise. Because transformer-based LLMs process information as discrete token embeddings rather than continuous time-series waves, the system utilizes a projection mechanism to format this data. The pre-processed signals are routed through either the edge-optimized CNN or the GCN, which act as feature encoders. These neural networks compress the complex spatial-temporal geometries and morphological features into dense, lower-dimensional latent vectors.

To input said ECG data into a neural network, the architecture employs one of two prompt-formatting methods depending on the LLM's modality. For textual or standard agentic LLMs, an authentication controller serializes the latent vectors, along with the calculated liveness and volition confidence scores, into a structured metadata format (e.g., a JSON payload). This structured physiological state is dynamically injected as a continuous, hidden system prompt (e.g., <system_state>liveness: verified, volition_score: 0.98, duress_flag: false </system_state>) prepended to the user's active session inputs, allowing the agent to continuously govern the session without polluting the user's conversational context. Alternatively, for natively multimodal LLMs, the dense vectors output by the CNN or GCN are mapped directly into the LLM's embedding space via a linear projection layer, allowing the transformer's attention mechanism to process the user's continuous biometric state exactly as it processes text tokens.

Agentic Session Lockout Protocol (authentication Controller 130)

The authentication controller 130 maintains an active session state, only while the combined liveness and volition confidence scores exceed a predefined threshold. An identity scoring module 132, a liveness scoring module 134 and a volition scoring module 136, can combine for an aggregate score meeting an aggregate score threshold, or be individually considered for individual score thresholds. In one case, the scoring modules are unevenly weighted to prioritize, per specific implementations. Also, an authentication policy can include deterministic rules, such as the requirement for continuous biometric data. In the age of Autonomous AI Agents, this continuous gating is critical to mitigating Session Hijack vulnerabilities where a session might otherwise remain open after a user departs. Upon the discontinuation of the verified biological signal or a failure to meet the volition threshold, the authentication controller executes an immediate, asynchronous lockout. This lockout protocol instantly shatters the active permission state and triggers an automatic memory-wipe of the associated AI agent's KV cache. Consequently, the access token is instantly revoked, isolating the agentic workflow and ensuring proprietary data remains secure the moment user persistence or free will is compromised.

Latent memory persistence in autonomous AI agents refers to the critical security vulnerability where highly sensitive conversational context and intermediate attention computations remain physically stored in hardware long after a user's session has nominally ended. To accelerate inference and handle long-context tasks, LLMs and agentic frameworks utilize a KV cache to store processed prompt data and token histories within HBM or offloaded persistent storage. Conventional session termination protocols, such as application-level context clearing or network-layer access token revocation—merely sever the communication link between the user interface and the agent. They do not actively destroy the underlying cached data. Consequently, the user's proprietary information persists in a latent plaintext state within the inference engine's memory until it is passively overwritten by dynamic memory management systems, such as a Least Recently Used (LRU) eviction policy. During this temporal window of latent persistence, the active KV cache is highly susceptible to extraction via side-channel attacks, cross-tenant cache sharing exploits, or advanced session hijacking. Therefore, relying on standard access revocation leaves a lingering vector for data exfiltration, necessitating a deterministic, hardware-level memory wipe that instantly sanitizes the agent's working memory upon the loss of verified biological liveness.

In another embodiment, the continuous biometric monitoring system is configured to support and govern a plurality of concurrent autonomous AI agent sessions executed on behalf of a single authenticated user. The verified state acts as a foundational cryptographic root of trust, which the authentication controller utilizes to continuously validate a plurality of distinct session access tokens simultaneously. Each validated access token is distinctly mapped to its respective agent's dynamically allocated memory block within the HBM. Parallel revocation of all active access tokens associated with that user triggers simultaneous, hardware-level memory wipes of the KV cache partitions for every concurrent agentic session, instantly neutralizing latent memory persistence across the user's entire multi-agent footprint. In alternative embodiments having individual agents governed by distinct operational policies tailored to their risk profiles and permission tiers, a concurrent agent operating under a different, unviolated governance policy remains fully active and its dedicated KV cache partition is not wiped. This granularity enables agent-specific security responses without terminating the user's entire multi-agent ecosystem.

A soft wipe and quarantine, in yet another embodiment, manages transient degradations in continuous biometric authentication. Rather than executing an absolute, destructive memory-wipe of the entire cache when an anomaly is detected, the authentication controller employs a multi-tiered revocation logic. If the calculated authentication score drops into a marginal confidence band—indicating a potential but unconfirmed loss of liveness or volition—the system maps and targets specific, highly-sensitive KV tensors within the HBM. These selectively mapped KV values are immediately removed from the active attention mechanism of the autonomous AI agent and placed into a temporary quarantine state. To ensure cryptographic security during this marginal state, the quarantined KV values are encrypted and transmitted back over the data communication network to the local authentication device (e.g., the user's wearable device) for secure, local retention. The remote AI agent may be paused or restricted to non-sensitive operations during this period. Crucially, this marginal confidence state may be triggered not by a change in the user's biological state, but by transient technical anomalies. Such anomalies include high network latency between the authentication device and the remote data center, temporary drops in the communication link, or sudden processing load spikes on the edge device that momentarily delay the continuous authentication signal. If the biometric authentication score subsequently recovers to an optimal level—verifying the disruption was merely a systemic hiccup or temporary sensor artifact rather than a true loss of biological liveness or volition, the local authentication device authorizes the release of the quarantined data. The encrypted KV values are then transmitted back to the remote LLM, decrypted, and seamlessly reintegrated into the active HBM cache. This soft wipe mechanism allows the system to temporarily isolate specific contextual data during borderline network or hardware circumstances without suffering the computational penalty of a complete, destructive hardware purge.

A multi-layer memory wipe, in further embodiments, to comprehensively eliminate the risk of latent memory persistence across a distributed network architecture, the session lockout protocol executes a synchronized, multi-layer memory wipe. While the primary deterministic wipe sanitizes the KV cache and intermediate activations physically located within the HBM at the remote AI accelerator, the system recognizes that fragments of session context, token histories, and prompt data may be temporarily buffered in other locations. Therefore, the asynchronous session lockout command propagates a cascading purge across all hardware and software layers involved in the agentic workflow. This includes immediate memory overwrite within higher-layer software environments, such as the host operating system buffers, memory pages, or session management middleware located at the remote server. Crucially, the multi-layer wipe also extends to the local computing environment, executing a localized purge of the Random-Access Memory (RAM) residing directly on the authentication device itself (e.g., the user's wearable or edge terminal). By actively destroying any locally-held context data that was queued or buffered to be later passed to the remote LLM, alongside all remote hardware and software instances of the KV cache—this multi-layer protocol ensures that no residual plaintext session data remains vulnerable to extraction anywhere within the end-to-end communication pipeline.

A secondary autonomous AI agent, in further embodiments, acts as a trusted personal proxy for the human user, continuously monitors the operational behavior of the primary autonomous AI agent. While the continuous biometric and volition authentication system may successfully verify the user's liveness and absence of duress—thereby satisfying the primary biological gating requirements—the secondary agent actively enforces a distinct set of operational, behavioral, or contextual policies (e.g., financial transaction limits, data privacy constraints, API access boundaries, or algorithmic hallucination detection). If this secondary personal agent detects that the primary agent is violating one or more of these auxiliary policies, the secondary agent is configured to execute an immediate override protocol. Crucially, even while the continuous biometric signals remain valid and the user's physical volition is actively confirmed, the secondary agent autonomously issues a session revocation command. This command acts as an inter-agent kill-switch, instantly triggering the deterministic, hardware-level memory wipe of the primary agent's KV cache. This multi-layered governance ensures that a rogue, compromised, or out-of-bounds primary agent can be asynchronously terminated by a localized proxy agent, dynamically securing the HBM and session data without requiring the human user to manually intervene or physically sever the biometric sensor connection.

In certain high-security embodiments, the system executes a silent session gating protocol with a honeypot upon a determination that the user is operating under physical coercion. Specifically, if the volition confidence score falls below a predefined volition threshold while the liveness confidence score and signature match remain valid, the system overrides the standard automatic session lockout and immediate memory-wipe of the associated AI agent's KV cache. Instead, the authentication controller silently revokes actual access permissions to the active session state. To deceive the coercing party and protect the genuine proprietary context, the system dynamically routes the active session state to a dummy database to create a honeypot environment. Simultaneously, the authentication device transmits a silent distress signal containing the user's location data to a remote security terminal.

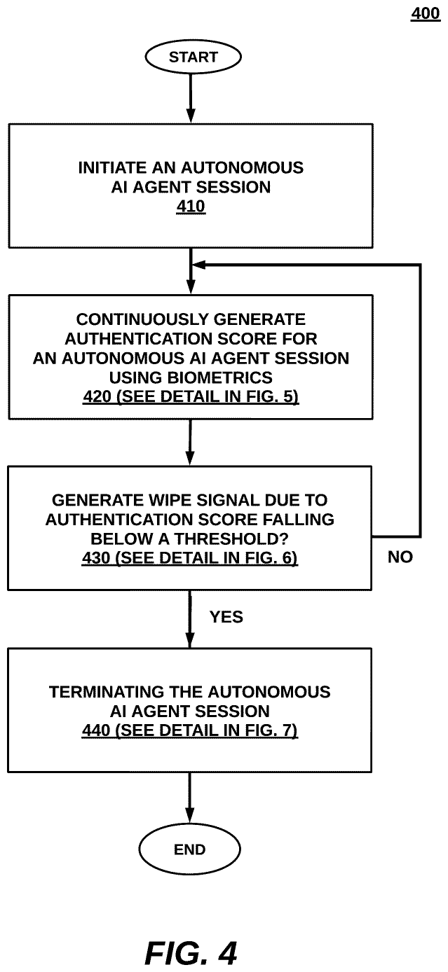

### II. Methods for Autonomous AI Agent Session Governance (FIGS. 4-7)

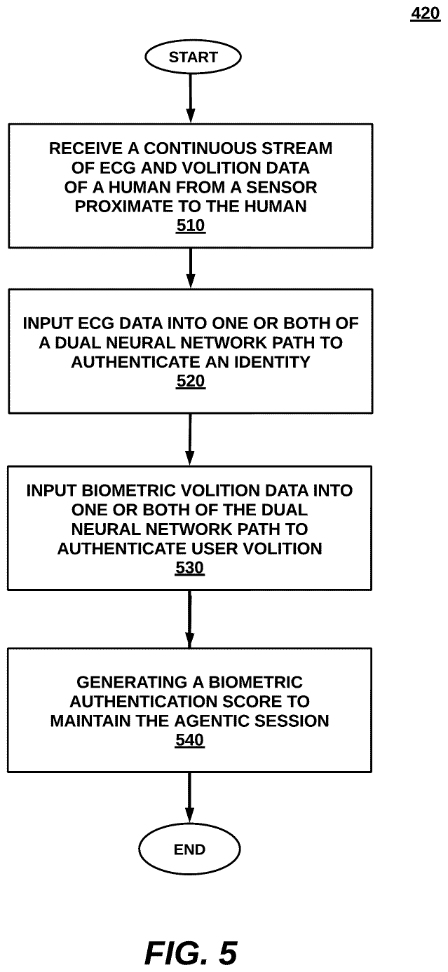

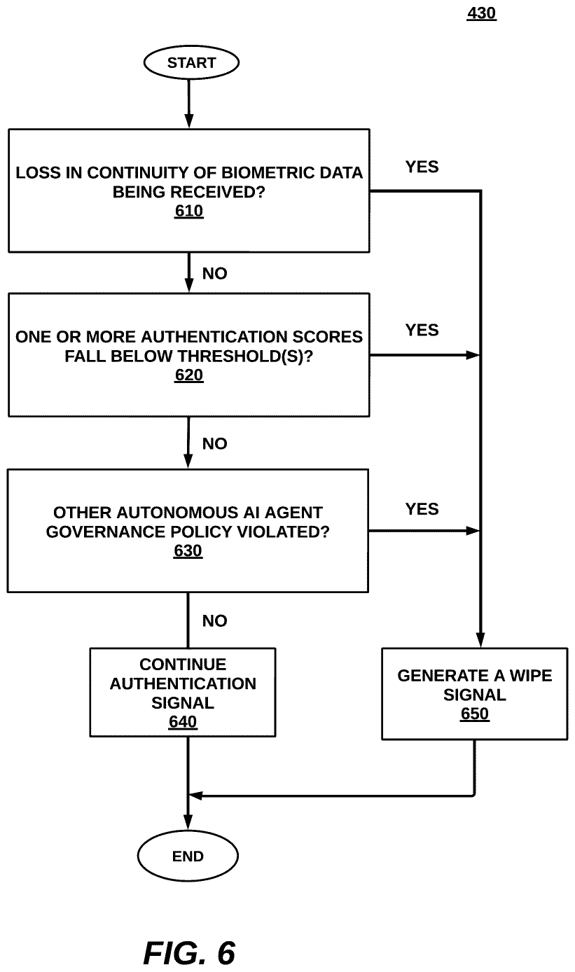

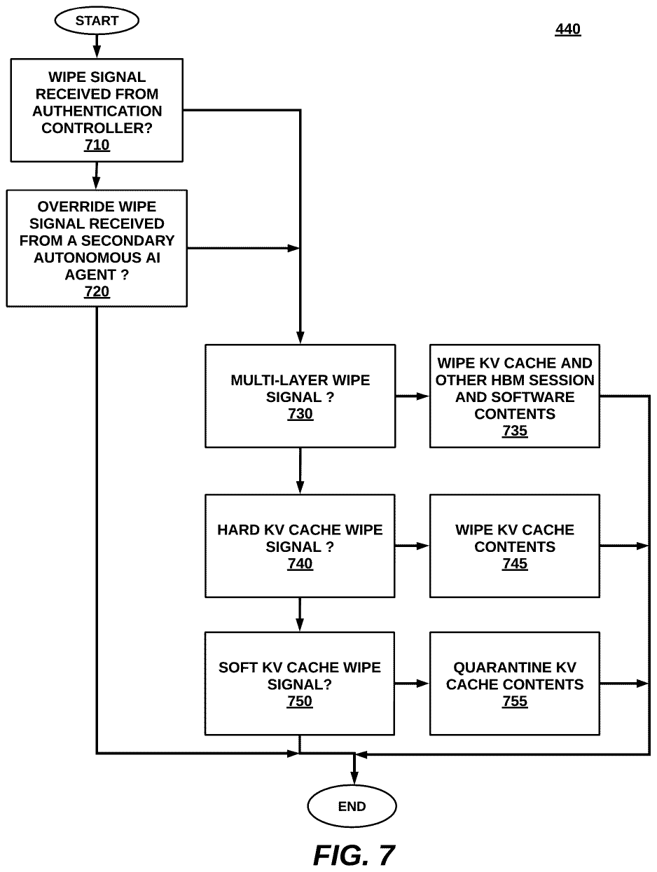

FIG. 4 is a flow chart illustrating a method 400 for governance of autonomous AI agent sessions with continuous neural network-driven authentication, according to an embodiment. An autonomous AI agent session is initiated (410). To maintain the session, continuous authentication score for the session is required, using human biometrics (420), as detailed below with reference to FIG. 5. In addition, liveness and volition authentication can be required. As detailed with respect to FIG. 6, loss of continuous authentication can result in a wipe signal being generated (430), either during an agentic session or after an AI agent completes tasks. The authentication loss can be triggered from a disconnection from the ECG system (e.g., no longer receiving ECG data stream) or from a loss in liveliness or volition confidence (e.g., aggregate or individual score falls below threshold). Moreover, the wipe signal can be generated by a second autonomous AI agent ensuring compliance with user or system governance polices. Responsive to the detection, the agentic session is terminated (440), as described below in association with FIG. 7.

FIG. 5 is a flow chart illustrating the step 420 of continuous biometric and volition authentication, from the method 400 of FIG. 4, according to an embodiment. More specifically, a continuous stream of ECG and volition data is received from a human user proximate (or attached) to the sensor (510). The data is generated by sensors that are either directly attached to an authentication device or wirelessly connected. Next, the ECG data is input to one or more neural network paths to authenticate identity (520). Biometric volition data can optionally be put into one or more neural networks to authenticate use volition, either initially or after start (530). A biometric authentication score can be generated, or biometric continuity verification, as an output for maintaining the agentic session, as required when the process returns to FIG. 5.

FIG. 6 is a flow chart illustrating the step 430 of generating a wipe signal responsive to losing continuous authentication or the secondary autonomous AI agent, from the method 400 of FIG. 4, according to an embodiment. If a loss in continuity of biometric data is detected (610), a wipe signal is generated (650). If no such continuity loss is detected, but one or more authentication scores fall below their respective thresholds (620), a wipe signal is generated (650). Similarly, if an autonomous AI agent governance policy is violated (630), a wipe signal is generated (650). If none of these conditions are triggered, the authentication signal continues to be generated (640).

FIG. 7 is a flow chart illustrating the step 440 of terminating the autonomous AI agent session, from the method 400 of FIG. 4, according to an embodiment. First, wipe signal can be received from the authentication controller (710), or an override wipe command can be received from the secondary autonomous AI Agent (720). User and system policies, such as hallucination detection, other governance violations, system timeout or other triggers can be automatically implemented separate from satisfactory continuous monitoring. In response, a multi-layer memory wipe is a wide-ranging approach that covers software copies and other hardware copies of sensitive content related to the KV cache stored within the AI architecture (730, 735). An immediate purge of all session-dependent computational states within the HBM, ensures that residual data in the I/O buffers and intermediate tensor calculations are destroyed alongside the KV cache to eliminate lingering vectors for data exfiltration. A hard KV cache wipe provides the simplest high security reaction for confirmed anomalies, the hardware wipe can be a complete destruction of contents within the KV cache (740, 745). Finally, a soft KV cache wipe is a more tenuous approach for anomalies that are not confirmed, amounting to a temporary quarantine of KV content, or in another case, selective destruction of KV content (750, 755). Many other variations are possible.

The above-mentioned methods are just examples in which steps can be performed in different orders and functions can be grouped differently. Many other variations of the above-described methods and steps are possible.

### III. Generalities of the Disclosure

This description of the invention has been presented for the purposes of illustration and description. It is not intended to be exhaustive or to limit the invention to the precise form described, and one of ordinary skill in the art will recognize many modifications and variations are possible in light of the teaching above. The embodiments were chosen and described in order to best explain the principles of the invention and its practical applications, in a concise manner. This description will enable others skilled in the art to best utilize and practice the invention in various embodiments and with various modifications as are suited to a particular use.

The scope of the invention is defined by the following claims.

We claim:

1. A computer-implemented method in an authentication device, for governance of autonomous artificial intelligence (AI) agent sessions with continuous neural network-driven identity authentication, the method comprising:
receiving a request to initiate a session for an autonomous AI agent executing on an AI processor associated with a Large Language Model (LLM), wherein the autonomous AI agent maintains a key-value (KV) cache in high-bandwidth memory (HBM) comprising, for each transformer attention layer, cached key tensors and value tensors;
receiving a continuous stream of electrocardiogram (ECG) data contemporaneously associated with and unique to the human user, from one or more sensors proximate to the human user;
inputting said ECG data into a neural network to compare against an ECG data baseline associated with the human user to generate an authentication score derived from a signature match and a liveness score;
maintaining an active session state for the autonomous AI agent only while the authentication score exceeds a threshold; and
responsive to the authentication score falling below said threshold, transmitting a signal that causes a memory-wipe of the key tensors and value tensors stored in the KV cache of the AI processor of the LLM as an asynchronous session lockout to terminate the session for the autonomous AI agent.

2. The method of claim 1, wherein the neural network comprises a Graph Convolution Network (GCN).

3. The method of claim 2, wherein the GCN is configured to model 12-lead ECG data as a spatial-temporal graph, using Mutual Information (MI) indices to define edges between lead-nodes.

4. The method of claim 2, wherein the authentication device is communicatively coupled to a data communication network, and the GCN performs remote inferencing at a remote location on the data communications network.

5. The method of claim 1, wherein the neural network comprises a Convolution Neural Network (CNN).

6. The method of claim 5, wherein the CNN performs edge-inferencing within the authentication device.

7. The method of claim 1, wherein the neural network comprises a dual-path neural network for dual modes, comprising a first mode for latency and/or power optimization utilizing a Convolution Neural Network (CNN), and a second mode for accuracy utilizing a Graph Convolution Network (GCN), and further comprising: receiving a mode selection.

8. The method of claim 1, wherein the continuous neural network-driven authentication governs a plurality of concurrent autonomous AI agent sessions executed on behalf of the human user, the method further comprising:
continuously validating a plurality of distinct session access tokens simultaneously utilizing the authentication score; and
responsive to the authentication score falling below said threshold, executing a synchronized, parallel revocation of all active access tokens associated with the human user to trigger simultaneous, hardware-level memory wipes of KV cache partitions for every concurrent agentic session of the plurality of concurrent autonomous AI agent sessions.

9. The method of claim 1, wherein the continuous neural network-driven authentication governs a plurality of concurrent autonomous AI agent sessions executed on behalf of the human user, the method further comprising:
continuously validating a plurality of distinct session access tokens simultaneously utilizing the authentication score; and
responsive to the authentication score falling below said threshold, executing a synchronized, parallel revocation of all active access tokens associated with the human user to trigger simultaneous, hardware-level memory wipes of KV cache partitions for every concurrent agentic session of the plurality of concurrent autonomous AI agent sessions.

10. The method of claim 1, wherein the continuous neural network-driven authentication governs a plurality of concurrent autonomous AI agent sessions executed on behalf of the human user, and wherein individual sessions of the plurality of concurrent autonomous AI agent sessions are governed by distinct operational policies, the method further comprising:
detecting a violation of a first operational policy associated with a first autonomous AI agent session of the plurality of concurrent autonomous AI agent sessions;
executing the asynchronous session lockout and the memory-wipe exclusively for a partitioned KV cache of the first autonomous AI agent session; and
maintaining the active session state for a second autonomous AI agent session of the plurality of concurrent autonomous AI agent sessions operating under a second, unviolated operational policy, such that a dedicated KV cache partition of the second autonomous AI agent session is not wiped.

11. The method of claim 1, further comprising enforcing a multi-party security requirement for the active session state of the autonomous AI agent by:
receiving a second continuous stream of ECG data contemporaneously associated with a second human user from a second sensor proximate to the second human user;
inputting said second ECG data into the neural network to generate a second authentication score derived from a second signature match and a second liveness score for the second human user, wherein maintaining the active session state for the autonomous AI agent requires that both the authentication score of the human user and the second authentication score of the second human user exceed the threshold, and wherein executing the asynchronous session lockout to terminate the session and the memory-wipe of the KV cache is triggered immediately upon either the authentication score of the human user or the second authentication score of the second human user falling below said threshold.

12. The method of claim 11, wherein the second human user is located at a remote location relative to the human user, and wherein the second continuous stream of ECG data is captured via the second sensor and transmitted, directly or indirectly, to the authentication device.

13. The method of claim 1, further comprising enforcing a multi-party security requirement for the active session state of the autonomous AI agent by:
securely receiving an indication from a second authentication device that is authenticated by the authentication device, of authentication of a second continuous stream of ECG data contemporaneously associated with a second human user from a second sensor proximate to the second human user.

14. The method of claim 1, wherein the tokenized session context includes at least one of: user-provided inputs, tool call results, intermediate reasoning states, and prior agent-generated outputs accumulated during the session.

15. The method of claim 1, wherein the authentication device comprises a wearable device configured for continuous contact with the human user, and the neural network executes on a processor of the wearable device.

16. The method of claim 1, wherein the KV cache is partitioned into dynamically allocated memory blocks residing within a physical memory of an AI accelerator, and wherein the hardware-level memory-wipe bypasses an operating system software-level context clearing by directly executing a physical memory overwrite of the dynamically allocated memory blocks containing the token histories.

17. The method of claim 1, further comprising:
enforcing a two-sided confirmation requirement for a multi-party security scenario by receiving a second continuous stream of ECG data contemporaneously associated with a second human user from a second sensor proximate to the second human user;
inputting said second ECG data into the neural network to generate a second authentication score derived from a second signature match and a second liveness score for the second human user,
wherein maintaining the active session state for the autonomous AI agent requires that both the authentication score of the human user and the second authentication score of the second human user exceed the threshold, and
wherein executing the asynchronous session lockout to terminate the session and the memory-wipe of the KV cache is triggered immediately upon either the authentication score or the second authentication score falling below said threshold.

18. The method of claim 1, wherein executing the memory-wipe comprises issuing, from the authentication device, a control signal to an AI accelerator that causes a hardware-level overwrite of physical memory blocks containing KV cache tensors, intermediate activations, and I/O buffers, bypassing any operating-system-level memory clearing.

19. A non-transitory medium storing computer-executable code in an authentication device that, when executed by a processor, performs a method for governance of autonomous artificial intelligence (AI) agent sessions with continuous neural network-driven identity authentication, the method comprising:
receiving a request to initiate a session for an autonomous AI agent executing on an AI processor associated with a Large Language Model (LLM), wherein the autonomous AI agent maintains a key-value (KV) cache in high-bandwidth memory (HBM)
comprising, for each transformer attention layer, cached key tensors and value tensors;
receiving a continuous stream of electrocardiogram (ECG) data contemporaneously associated with and unique to the human user, from one or more sensors proximate to the human user;
inputting said ECG data into a neural network to compare against an ECG data baseline associated with the human user to generate an authentication score derived from a signature match and a liveness score;
maintaining an active session state for the autonomous AI agent only while the authentication score exceeds a threshold; and
responsive to the authentication score falling below said threshold, transmitting a signal that causes a memory-wipe of the key tensors and value tensors stored in the KV cache of the AI processor of the LLM as an asynchronous session lockout to terminate the session for the autonomous AI agent.

20. An authentication device for governance of autonomous artificial intelligence (AI) agent sessions with continuous neural network-driven identity authentication, the authentication device comprising:
a processor; and
a memory, communicatively coupled to the processor and storing computer-executable code that, when executed by the processor, is configured to:
receive a request to initiate a session for an autonomous AI agent to execute on an AI processor associated with a Large Language Model (LLM), wherein the autonomous AI agent maintains a key-value (KV) cache in high-bandwidth memory (HBM) comprising, for each transformer attention layer, cached key tensors and value tensors;
receive a continuous stream of electrocardiogram (ECG) data contemporaneously associated with and unique to the human user, from one or more sensors proximate to the human user;
input said ECG data into a neural network to compare against an ECG data baseline associated with the human user to generate an authentication score derived from a signature match and a liveness score;
maintain an active session state for the autonomous AI agent only while the authentication score exceeds a threshold; and
responsive to the authentication score falling below said threshold, transmit a signal that causes a memory-wipe of the key tensors and value tensors stored in the KV cache of the AI processor of the LLM as an asynchronous session lockout to terminate the session for the autonomous AI agent.
